(19) United States
(12) Patent Application Publication
(10) Pub. No.: US 2020/0207396 A1
(43) Pub. Date: Jul. 2, 2020

(54) PALLET TRUCK FIXTURE

(71) Applicant: Tom Espy, Olathe, KS (US)

(72) Inventor: Tom Espy, Olathe, KS (US)

(21) Appl. No.: 16/235,139

(22) Filed: Dec. 28, 2018

(51) Int. Cl. B62B 5/00; B66F 9/12

(52) U.S. Cl. CPC B62B 5/0003; B66F 9/12

(57) ABSTRACT

The present disclosure relates to fixtures for facilitating the lifting and/or moving of a pallet truck, such as an electrically-powered pallet jack. Some embodiments of the invention increase the safety and effectiveness of moving pallet trucks, thereby addressing an opportunity for improvement in the art identified by the applicants.

### FIELD OF THE DISCLOSURE

The present invention relates to novel detachable fixtures for facilitating the lifting and/or moving of a pallet truck (e.g., a pallet jack) in the art of materials handling, and methods for using the same.

### BACKGROUND

In the art of materials handling, pallets are often used to hold one or more containerized load(s), for example, so that a pallet truck (e.g., a pallet jack) or forklift truck can be employed for lifting, transporting, and otherwise handling the load(s). A conventional pallet is comprised of parallel, horizontal stringers and crossboards, nailed together to form a rectangular element. A load is placed on the surface of the pallet, so that the load can be lifted and/or moved as a unit from beneath. In the United States, pallets are typically about 4 feet long by 4 feet wide. The rectangular element of the pallet contains spaces that can accommodate inserted forks of a pallet truck or forklift truck. The forks are inserted into the spaces, so that the pallet (e.g., with a surface-disposed load) may then be lifted, for example, to transport the load from one location to another.

Pallet trucks typically include forks upon which rollers are mounted at terminal ends. The opposing ends of the forks are typically connected to one another and attached in some fashion to a body comprising a pivotal wheel with a lifting mechanism. The pivotal wheel allows the user to steer the pallet truck while it is in motion. The lifting mechanism raises and lowers the forks to engage and transport the pallet, or to disengage the pallet truck from the pallet. Lifting mechanisms of pallet trucks are typically hydraulic, pneumatic, or electric mechanisms. Generally, the lifting mechanism comprises the heaviest portion of an unladen pallet truck.

When a pallet truck itself (i.e., without a pallet load lifted thereby) is required to be transported, conventional practice is to slide the forks of a forklift to under the pallet truck to lift and transport it.

### BRIEF SUMMARY OF THE DISCLOSURE

This Brief Summary is provided to introduce a selection of concepts in a simplified form. These concepts are described in further detail in the Detailed Description of exemplary embodiments of the disclosure below. This Brief Summary is not intended to identify key features or essential features of subject matter identifiable from the disclosure by those in the art, nor is it therefore limiting with respect to the scope of any claim setting forth the bounds of the applicants' rights.

Disclosed herein are detachable pallet truck fixtures that are engageable with a pallet truck (e.g., a pallet jack) to facilitate lifting and suspension of the pallet truck, for example, during transport of the pallet truck. The detachable fixture may be used to lift and cradle a pallet truck with a point of engagement beneath, or as close as practicable to, the center of gravity of the pallet truck; for example, directly beneath the heaviest portion of the pallet truck (e.g., the battery area of an electrically-powered pallet jack). Upon cradling the pellet truck with the fixture, the pallet truck can be lifted and transported efficiently and safely.

In some embodiments, a pallet truck fixture may include a load-engaging element and a mounting element comprising one or more guide elements, the load-engaging element and the mounting element being connected by a support frame. In other embodiments, the load-engaging element of the pallet truck fixture may be adapted for disposition beneath a pallet truck; for example, between the tines and beneath the battery area of an electrically-powered pallet jack. In alternative embodiments, the mounting element may comprise an upper surface and a lower surface, separated by guide element(s).

The applicants have discovered that disadvantages of conventional practices for transporting pallet trucks, such as pallet jacks, include a propensity of the pallet truck to be unstable during transport, and limitations with respect to the loading and unloading of the pallet truck. For example, when the forks of a forklift are used to slide under a pallet jack, so that the forklift can then lift and transport the pallet truck, there is a significant risk that the pallet jack will shift, slide off, and/or be dropped. Lifting the pallet truck from underneath also normally prevents the pallet truck from being loaded or unloaded over a barrier, such as the sidewalls of a pickup bed or trailer. Furthermore, sliding the forks of a forklift under a pallet truck normally limits the sides of the pallet truck from which the forks can approach the pallet truck to adequately support the weight of the pallet truck during lifting. Pallet truck fixtures according to particular embodiments herein alleviate some or all of the foregoing disadvantages, allowing a user to support the weight of a pallet truck from beneath its center of gravity, load or unload the pallet jack over a barrier, and/or to lift the pallet truck from any side of the pallet truck.

Also disclosed herein are methods for utilizing a pallet truck fixture of the invention to form a pallet truck-pallet truck fixture assembly. In certain embodiments, such methods comprise engaging the load-engaging element of the pallet truck fixture with a pallet truck, for example, supporting the pallet truck with the load-engaging element at a point of engagement beneath the center of gravity of the pallet truck, or as close as is practicable, thereby forming the pallet truck-pallet truck fixture assembly. In particular embodiments, the point of engagement of the load-engaging element and the pallet truck is directly beneath the heaviest portion of the pallet truck (e.g., the battery area of an electrically-powered pallet jack). In particular embodiments, the load-engaging element engages the pallet truck at a point between the forks of the pallet truck.

Also disclosed are methods for lifting a pallet truck. In embodiments, such methods comprise lifting a pallet truck-pallet truck fixture assembly with a lifting element (e.g., the forks of a forklift) engaged to the mounting element of the pallet truck in the assembly. One such method may comprise engaging the mounting element of the pallet truck fixture in a pallet truck-pallet truck fixture assembly with a lifting element, for example, using one or more guide elements of the mounting element. In particular embodiments, the lifting element may engage the mounting element from any direction, for example, from the front, back, or either side of a rectangular mounting element. When the pallet truck-pallet truck fixture assembly is lifted, the engaged lifting element is positioned above the base of the assembly at a height approximately equal to the length of a support frame operably connecting the load engaging element and mounting element of the pallet truck fixture.

Also disclosed are methods for transporting a pallet truck. In embodiments, such methods comprise utilizing a conveyance to transport a pallet truck-pallet truck fixture assembly from one location to another location, where the conveyance comprises a lifting element engaged to the mounting element of the assembly. In some embodiments, the conveyance is a forklift comprising forks that are the engaged to the mounting element of the pallet truck fixture in the pallet truck-pallet truck fixture assembly. In specific embodiments, the ability to engage the assembly from a particular direction allows the assembly to be transported, for example, such that it can be deposited in a particular orientation after transport through narrow and/or constrained spaces. For example, the forks of a forklift may be engaged to the side of a rectangular mounting element, so that the assembly can be placed facing forward at a location that cannot be approached from the front or rear using a forklift. In particular embodiments, the positioning of the engaged lifting element above the base of the assembly at a height approximately equal to the length of a support frame allows for the assembly to be deposited over a barrier having a height less than the distance separating the lifting element and the base of the assembly, without contacting the barrier with the lifting element.

The foregoing and other features will become more apparent from the following Detailed Description of several embodiments, which proceeds with reference to the accompanying Drawings.

### BRIEF DESCRIPTION OF THE DRAWINGS

FIG. 1(a-c) includes views of an exemplary pallet truck fixture; FIG. 1a includes a perspective view; FIG. 1b includes a side view of the fixture, and FIG. 1c includes a front view of the fixture.

FIG. 2a includes exemplary manufacturing specifications for a load-engaging element of pallet truck fixtures according to specific embodiments. FIG. 2b includes a top view of an exemplary pallet truck fixture, showing the relative extension of load-engaging element members in certain examples.

FIG. 3(a-b) includes exemplary manufacturing specifications for a mounting element of pallet truck fixtures according to specific embodiments; FIG. 3a includes exemplary specifications for a first surface of the mounting element comprising a plurality of guide elements, and FIG. 3b includes exemplary specifications for a second surface of the mounting element.

FIG. 4 includes exemplary manufacturing specifications for a support frame of pallet truck fixtures according to specific embodiments.

FIG. 5(a-c) includes images of modes of operation of an exemplary pallet truck fixture. FIG. 5a includes an image of a pallet truck fixture at rest on a floor surface. FIG. 5b includes an image of a pallet truck fixture engaged with an electrically-powered pallet jack. FIG. 5c includes an image of an electrically-powered pallet jack-pallet truck fixture assembly suspended by a forklift.

### DETAILED DESCRIPTION

Disclosed generally herein are novel detachable pallet truck fixtures that introduce specific and significant improvements to the lifting and transport of pallet trucks (e.g., unladen pallet jacks), and method for using the same. In specific embodiments, a pallet truck fixture is adapted for use with an electric pallet jack comprising a battery. Pallet truck fixtures described herein offer a safe way to handle, load, and/or transport pallet trucks, lifting the pallet truck at its heaviest point, such that the suspended pallet truck is balanced to avoid losing control of the pallet truck during its transport or loading. Pallet truck fixtures herein may also provide the user with multiple lifting options, such as, for example, from the front, rear, or either side of a pallet truck, while always lifting from the center point. Pallet truck fixtures herein may also allow the user to load or unload a pallet truck over the side of a barrier; for example, into or out of a pickup bed or a trailer where the sidewalls of the truck or trailer prevent lifting elements from reaching the base of the pallet truck.

While embodiments of the invention are illustrated and exemplified in detail in the Drawings and following Detailed Description, the invention is not limited to the particular illustrations or examples. Other variations of the examples are immediately and directly identified and understood by those skilled in the art from a study of the present disclosure. In the specification and claims, the terms “comprising” and “including” are open-ended, and do not exclude other elements or steps, and the indefinite article “a” or “an” does not exclude a plurality. Furthermore, the mere fact that certain elements are recited in mutually different dependent claims does not indicate that a combination of the elements is not also included within the scope of the invention.

Illustrations presented herein are not meant to be actual views of any particular fixture or element, but are merely simplified schematic representations employed to illustrate particular examples. For example, the illustrations in the Drawings are not necessarily to scale. Also, any relational term, such as “first,” “second,” “over,” “beneath,” “top,” “bottom,” “underlying,” “up,” “down,” etc., is used for clarity and convenience in understanding the disclosure, and does not connote or depend on any specific preference, orientation, or order, except where the context clearly indicates otherwise.

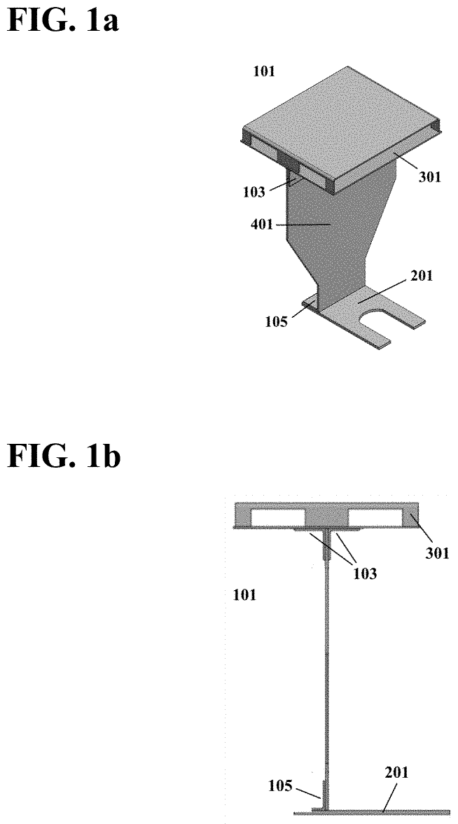

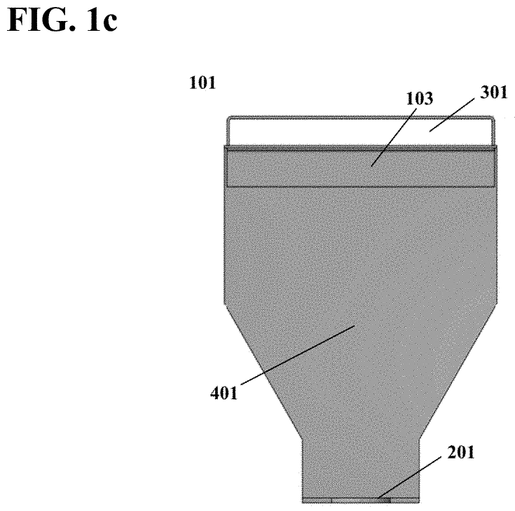

FIG. 1a is a perspective view of an exemplary pallet truck fixture 101 according to some embodiments. The pallet truck fixture 101 comprises a load-engaging element 201 that is adapted to engage a pallet truck at a point below the center of a pallet truck. The pallet truck fixture 101 may also comprise a mounting element 301 that is adapted to receive at least one lifting element, for example, forks of a forklift or forklift truck. The load-engaging element 201 and the mounting element 301 can be connected by a support frame 401, which may be attached to the load-engaging element 201 and/or the mounting element 301 by means for attachment (e.g., a weld, fasteners, elbow plates 103, 105, etc.).

Referring to FIG. 1b, the load-engaging element 201 may be attached to the support frame 401 by an elbow plate 105 over a joint on the upper surface of the load-engaging element 201 and the rear surface of the support frame 401. Referring to FIG. 1b and FIG. 1c, the mounting element 301 may be attached to the support frame 401 by two elbow plates 103, over both joints between the lower surface of the mounting element 301 and the front and rear surfaces of the support frame 401. Referring to FIG. 1c, the support frame 401 may be a plate element with an edge contacting the load-engaging element 201 and an edge contacting the mounting element 301. In alternative examples, the support frame 401 may be a pole or comprise a spring.

The load-engaging element 201 of the pallet truck fixture 101 engages and supports the weight of a pallet truck from its center.

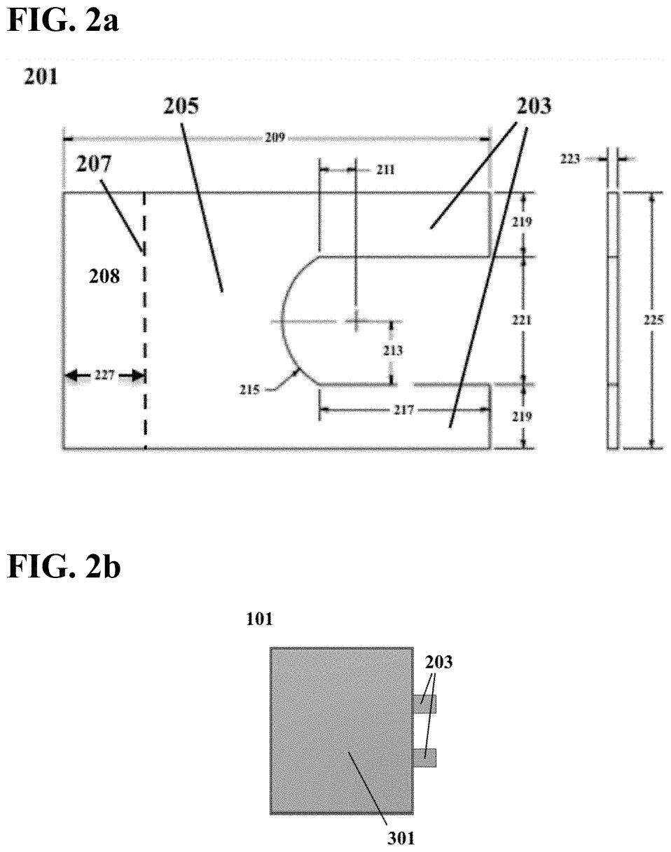

Referring to FIG. 2a, the load-engaging element 201 has a length 209 in the front-rear axis of the pallet truck fixture 101, a width 225 in the side-side axis, and may be constructed of a suitable load-bearing material with a thickness 223. The load-engaging element 201 may comprise at least one lateral member 203 with a width 219, that extend(s) from the load-engaging element body 205 in the direction of the pallet truck during engagement. In particular embodiments, the length 209 of the load-engaging element 201 may be about 1⅔× the width 225 of the load-engaging element 201. In these and other embodiments, the length 209 of the load-engaging element 201 may be about 20 inches, the width 225 may be about 12 inches, and the thickness 223 may be between about 0.25 and 0.75 inches; for example, about 0.5 inches. In particular embodiments, the width 219 of the lateral member(s) 203 may be about ¼× the width of the load-engaging element 201. In these and other embodiments, the width 219 of the lateral member(s) 203 may be about 3 inches.

FIG. 2b is a top view of an exemplary pallet truck fixture 101, showing that lateral members 203 of the load-engaging element 201 may extend beyond the front edge of the mounting element 301. In particular embodiments, the lateral members 203 of the load-engaging element 201 may extend beyond the front edge of the mounting element 301 to a distance of between about 0.15× and 0.20× (e.g., about 0.16×) the length of the mounting element 301 in the direction of the front-rear axis. In these and other embodiments, the lateral members 203 of the load-engaging element 201 may extend beyond the front edge of the mounting element 301 to a distance of about 3 13/16 inches.

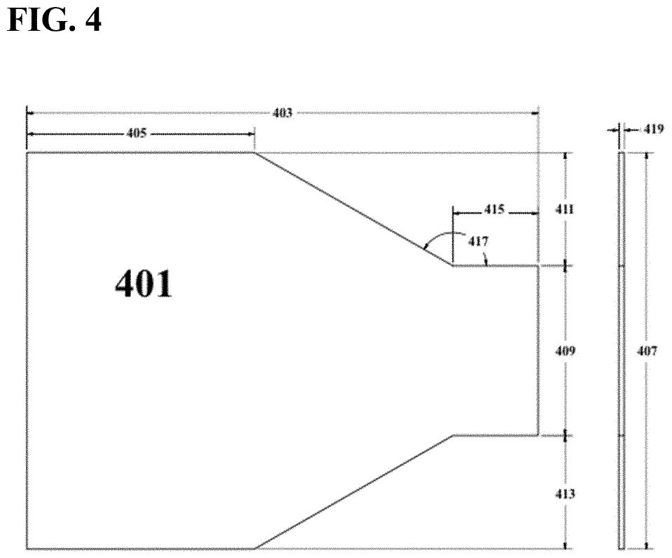

The load-engaging element 201 may comprise a point of attachment 207 with the support frame 401, represented in FIG. 2a by a line contacting a plate-shaped support frame 401, as illustrated in FIG. 4, such that the load-engaging element 201 comprises a rear foot element 208 that extends a length 227 from the attached support frame 401. In particular embodiments, the rear foot element 208 may have a length 227 that is about ⅕× the length 209 of the load-engaging element 201; for example, the length 227 of the rear foot element may be about 4 inches. In embodiments wherein the load-engaging element 201 comprises a plurality of (e.g., two) lateral members 203, as illustrated in FIG. 2, the lateral members 203 are separated by a space having a width 221. In particular examples of such embodiments, the width 221 separating the lateral members 203 may be about ½× the width of the load-engaging element 201. In certain such examples, the width 221 may be about 6 inches.

FIG. 2a illustrates design specifications for an exemplary load-engaging element 201 comprising two lateral members 203 and a body 205. According to this particular manufacturing strategy, the space separating the lateral members 203 is defined on one side by a concave edge 215 of the load-engaging element body 205. In such examples, the concave edge 215 may be defined by a circle having a center located at a distance 213 from the lateral members 203, and at a depth 211 from the rear end of the lateral members 203. In particular embodiments, the concave edge 215 of the load-engaging element body 205 is defined by a circle having a center located equidistantly from two lateral members 203, and at a depth 211 from the rear end of a lateral member 203 that may be about 0.3× the width 221 of the space separating the lateral members 203. For example, the circle defining the concave edge 215 of the load-engaging element body 205 may have a center located about 3 inches from each of two lateral members 203, and about 1¾ inches from the rear end of each of the two lateral members 203.

During lifting and transport, at least one lifting element (e.g., forks of a forklift or forklift truck) are engaged with the mounting element 301, such that upwards movement of the lifting element(s) lifts the pallet truck fixture 101, and holding the lifting element(s) in the upward position suspends the pallet truck fixture 101 during transport of the pallet truck fixture 101, with any engaged pallet truck in a pallet truck-pallet truck fixture assembly.

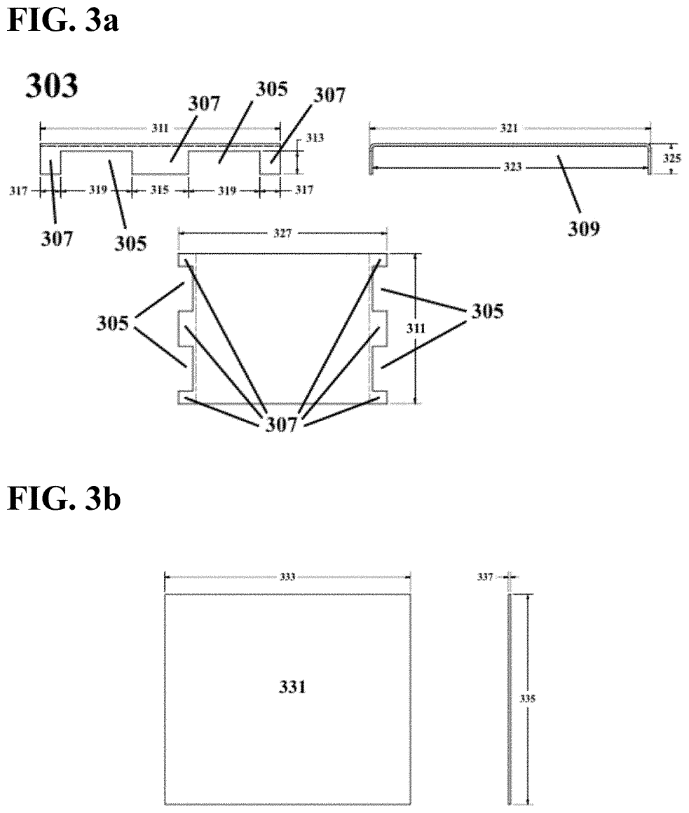

Referring to FIG. 3, the mounting element 301 may be a structure comprising an upper plate 303 (FIG. 3a) and a lower plate 331 (FIG. 3b). The upper plate 303 and the lower plate 331 each have a thickness 337, and one or both of the upper plate 303 and the lower plate 331 may be substantially rectangular in shape, so that the upper plate 303 has a length 311 and width 321, or the lower plate 331 has a length 333 and width 335.

The mounting element 301 may also comprise one or more guide elements 305. In the illustrated example of FIG. 3a, two guide elements 305 are adapted to receive the forks of a forklift truck on the lateral sides of the mounting element 301, such that the pallet truck fixture 101 can be lifted from the side. However, the front and rear of the mounting element 301 each comprise a single guide element 309 of sufficient width 323 to receive the forks of a forklift truck, such that the pallet truck fixture 101 can be lifted from the front or rear. The lateral guide elements 305 may be spaces having a height 313 and width 319, defined by solid lateral elements 307 with a height 313 and width 315, 317. The front and rear guide elements 309 may also be a space, having a height 325 and width 323. While a rectangular mounting element 301 is illustrated in FIG. 1, FIG. 2b, and FIG. 3, it will be understood by those in the art that other shapes are useful and can be selected within the discretion of the user according to applications utilizing particular lifting elements and associated articles.

FIG. 3 illustrates design specifications for an embodiment of a mounting element 301 comprised of two plates 303, 331. According to this particular manufacturing strategy, the upper plate 303 may be formed from an initial plate having a length 311 and width 327, by folding on opposing edges of the plate, where the opposing edges comprise solid lateral elements 307 that will define guide element 305 spaces when the distal end of the lateral elements 307 is attached to the lower plate 331. In particular embodiments the upper plate 303 and/or lower plate 331 may have a thickness 337 of between about 0.25 and 0.75 inches; for example, about 0.25 inches. In these and other embodiments, the length 311 of the upper plate may be approximately equal to the length 333 of the lower plate 331, and/or the width 321 of the upper plate 303 may be approximately equal to the width 335 of the lower plate 331; for example, the length 311, 333 and width 321, 335 of the upper plate 303 and/or lower plate 331 may be approximately equal to the length and width of a pallet of the sort for use with a pallet truck (e.g., a pallet jack) for which the pallet truck fixture 101 is adapted for use. For example, the upper plate 303 may have a length 311 of about 23.5 inches, and/or a width 321 of about 27.5 inches; similarly, the lower plate 331 may have a length 333 of about 24 inches, and width 335 of about 28 inches.

Also according to the particular manufacturing strategy illustrated in FIG. 3, the mounting element 301 includes two lateral guide elements 305 comprised of spaces having a height 313 and width 319 that are sufficient to allow easy engagement of lifting elements according to specific applications; for example, having a height 313 that is about 2.25 inches, and a width 319 that is about 7 inches (e.g., for easy engagement of the forks of a forklift). In these and other examples, the front and/or rear of the mounting element 301 may comprise a single guide element 309 having a width 323 that is approximately the width 321, 335 of the upper plate 303 or lower plate 331; for example, about 27 inches.

The support frame 401 is operatively attached to the load-engaging element 201 and the mounting element 301, such that the pallet truck fixture 101 can withstand the combined mass of the pallet truck fixture 101 and a pallet truck in a suspended pallet truck-pallet truck fixture assembly, during both lifting and transport of the assembly. The support frame 401 may be comprised of a plate constructed from a rigid material with a thickness 419. Alternatively, the support frame 401 may be a rod or any other appropriate structure, constructed from a material with a suitable degree of elasticity, and/or comprising a spring.

Referring to FIG. 4, the support frame 401 may be comprised of a plate with a thickness 419, having a side height 403 and a tapered design. For example, the support frame 401 may comprise an upper edge with a width 407, and a lower edge with a width 409, where the plate is tapered, such that the width 407 of the upper edge is greater than the width 409 of the lower edge. In particular embodiments, the width 411, 413 of the space on each side of the lower edge may be wider than the tins of a pallet truck to be engaged by the pallet truck fixture 101. This arrangement allows the load-engaging element 201 to slide beneath the center of a pallet truck while tines of the pallet truck are disposed around the load-engaging element when the pallet truck fixture 101 is engaged with the pallet truck.

FIG. 4 illustrates design specifications for an exemplary support frame 401 According to this construction strategy, the taper of the support frame 401 begins at a distance 405 from the upper edge of the support frame 401 and concludes at a distance 415 from the lower edge of the support frame 401, where the shape of the taper is defined by an angle 417 between a cut line from the side and a cut line from the lower edge. In particular embodiments including this strategy, the support frame 401 is comprised of a plate with a thickness 419 of between about 0.25 and 0.75 inches; for example, about ⅜ inches, having a tapered design characterized by a side height 403 that corresponds approximately to the desired vertical position of a lifting element when the pallet truck fixture 101 is lifted; for example, about 36 inches, where the upper edge of the support frame 401 has a width 407 that is approximately equal to the width of the mounting element 301 (for example, about 28 inches), and the lower edge of the support frame 401 has a width 409 that is approximately equal to the width of the load-engaging element 201 (for example, about 12 inches), defining spaces 411, 413 on each side of the lower edge with widths of, for example, about 8 inches. The taper of the support frame 401 may begin at a distance 405 of about 16 inches from the upper edge of the support frame 401, and conclude at a distance 415 of about 6 inches from the lower edge of the support frame 401, with an angle 417 of about 150° between the cut line from the side of the mounting element 401 and the cut line from the lower edge.

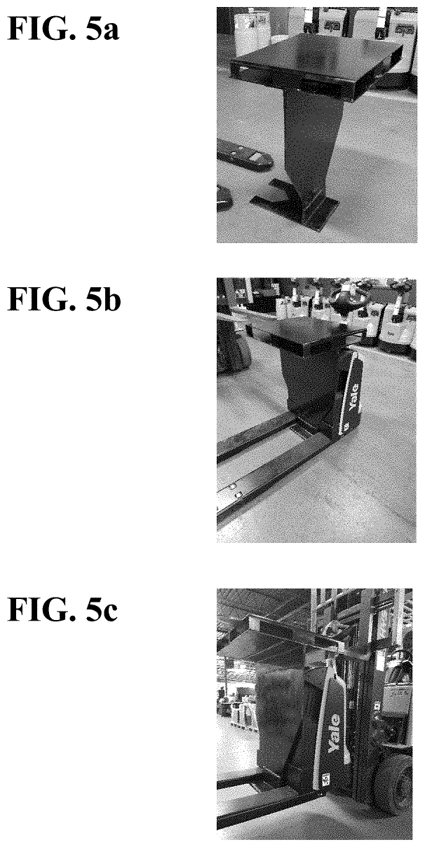

Referring to FIG. 5, when the pallet truck fixture 101 is not in use, it may be capable of standing upright in a stable position, as shown in FIG. 5a. Such embodiments may facilitate storage of the pallet truck fixture in certain environments. In the example illustrated in FIG. 5a, the load-engaging element 201 comprises a rear foot element 208, a body 205, and lateral elements 203 of dimensions appropriate to stably balance the weight of the pallet truck fixture 101. When the pallet truck fixture 101 is engaged with a pallet truck (FIG. 5b), the combination is referred to herein as a “pallet truck-pallet truck fixture assembly.” In the example illustrated in FIG. 5b, the pallet truck fixture 101 in the assembly is engaged with the pallet truck by the slidable positioning of the load-engaging element 201 beneath the center of the electrically-powered pallet truck shown, between its two tines. In this exemplary engagement, lateral guide elements 305 engage the forks of a forklift as lifting elements on each side of the assembly, while a front (and rear) guide elements 309 engage lifting elements (e.g., forks of a forklift) on the front and rear of the assembly. When lifting elements engage the mounting element 301 of the pallet truck in the pallet truck-pallet truck fixture assembly (FIG. 5c), lifting of the pallet truck-pallet truck fixture assembly is accomplished by raising the lifting elements.

What may be claimed is:

1. A detachable fixture for lifting a pallet truck, the fixture comprising:
a load-engaging element adapted to engage the pallet truck beneath its heaviest portion;
a support frame; and
a mounting element comprising one or more guide elements, wherein the load-engaging element and the mounting element are operably connected by the support frame.

2. The detachable fixture of claim 1, wherein the load-engaging element is adapted to engage the pallet truck beneath its center.

3. The detachable fixture of claim 1, wherein the load-engaging element is adapted to engage a pallet truck comprising a plurality of extended forward fork between the forks.

4. The detachable fixture of claim 1, wherein the load-engaging element has a length sufficient to support and balance the weight of the fixture in an upright position.

5. The detachable fixture of claim 1, wherein the support frame comprises a tapered plate.

6. The detachable fixture of claim 1, wherein the support frame is attached to the load-engaging element and the mounting element by elbow plates.

7. The detachable fixture of claim 1, wherein the mounting element is rectangular in shape.

8. The detachable fixture of claim 1, wherein the mounting element comprises an upper surface and a lower surface, wherein the guide elements are between the upper surface and the lower surface.

9. The detachable fixture of claim 1, wherein the guide elements are spaces adapted to receive the forks of a forklift truck.

10. A method for producing a liftable pallet truck assembly, the method comprising:
engaging the load-engaging element of the pallet truck fixture of claim 1 with a pallet truck.

11. The method according to claim 10, wherein the pallet truck is a pallet jack.

12. The method according to claim 11, wherein the pallet truck is an electrically powered pallet jack with a battery, and wherein engaging the load-engaging element of the pallet truck fixture with the pallet truck comprises positioning the load-engaging element of the pallet truck fixture between the tines and beneath the battery of the electrically powered pallet jack.

13. The method according to claim 10, the method further comprising engaging a lifting element with the mounting element of the pallet jack fixture.

14. The liftable pallet truck assembly comprising the pallet truck fixture of any of claims 1-9 produced by the method according to claim 10.

15. The liftable pallet truck assembly of claim 14, further comprising a lifting element engaged with the mounting element of the pallet jack fixture.

16. The liftable pallet truck assembly of claim 15, wherein the lifting element is one or more forks of a forklift.

17. A method for safely cradling a pallet truck, the method comprising:
raising the engaged lifting element of the liftable pallet truck assembly of claim 16.

18. The method according to claim 17, wherein the cradling comprises transporting the pallet truck assembly to a new location.

19. The method according to claim 17, the method further comprising lowering the engaged lifting element until the liftable pallet truck assembly rests on a surface.

20. The method according to claim 17, wherein the method comprises lifting or lowering the pallet truck assembly over a barrier.

21. The method according to claim 20, wherein the barrier is a sidewall of a truck bed or trailer bed.

22. A materials handling system comprising:
at least one pallet truck; and
the detachable pallet truck fixture of claim 1, wherein the load-engaging element of the pallet truck fixture is adapted to engage the pallet truck beneath its heaviest portion.

23. The materials handling system of claim 22, wherein the pallet truck is a pallet jack.

24. The materials handling system of claim 22, further comprising a device comprising a lifting element, wherein the one or more guide elements of the pallet truck fixture mounting element are adapted to engage the lifting element.

25. The materials handling system of claim 24, wherein the device is a forklift or forklift truck, and the lifting element comprises forks of the forklift or forklift truck.
